(19) United States
(12) Patent Application Publication
(10) Pub. No.: US 2025/0131745 A1
(43) Pub. Date: Apr. 24, 2025

(54) LANE LINE DETECTION METHOD AND SYSTEM

(71) Applicant: MiTAC Digital Technology Corporation, Taoyuan City (TW)

(72) Inventor: Hsiang-Yu Hsieh, Taoyuan City (TW)

(21) Appl. No.: 18/918,587

(22) Filed: Oct. 17, 2024

(30) Foreign Application Priority Data
Oct. 20, 2023 (TW) 112140102

(51) Int. Cl. G06V 20/56; G01C 21/28; G06V 10/56; G06V 10/74; G06V 10/75

(52) U.S. Cl. CPC G06V 20/588; G01C 21/28; G06V 10/56; G06V 10/751; G06V 10/761

(57) ABSTRACT

A method is provided for a travelling vehicle to detect lane lines. A front camera module captures frames of front image of the vehicle, a rear camera module captures frames of rear image of the vehicle, and a speed sensor module senses speed trajectory of the vehicle. In the method, the frames of front image, the frames of rear image and the sensed speed trajectory are used to obtain pairs of matched front and rear images, and to determine reliability of a lane line feature detected in a current front image or a current rear image based on the pairs of matched front and rear images, and the lane line feature detected from the current front image or the current rear image is outputted upon determining that the currently detected lane line feature is reliable.

### CROSS-REFERENCE TO RELATED APPLICATION

This application claims priority to Taiwanese Invention Patent Application No. 112140102, filed on Oct. 20, 2023, the entire disclosure of which is incorporated by reference herein.

### FIELD

The disclosure relates to lane line detection, and more particularly to a lane line detection method and a lane line detection system.

### BACKGROUND

Lane departure warning systems have become a standard feature in newly manufactured vehicles. On the other hand, for devices that are adapted to advanced driver assistance systems (ADAS) in the aftermarket of vehicles, such as dashcams, their performance is often restricted by the performance of wide-angle lenses (e.g., image distortion that often occurs at the edges of wide-angle lenses), low frame rates, etc., and depends on physical environment conditions, weather, etc., which may restrict the image recognition accuracy of ADAS.

Conventional image-recognition-based lane line detection methods utilize simple image recognition techniques or perform image detection through neural network models. However, the technology actually used in dashcams often has reduced complexity with respect to image recognition algorithms or neural network architectures in order to meet performance requirements in terms of time. This reduction in algorithm or neural network complexity may affect the accuracy of image recognition and may lead to an increase in false alerts and/or missed detection rates in lane departure warnings due to inaccurate image recognition.

### SUMMARY

Accordingly, developing a method that is adapted to be used with dashcams during outdoor driving where the actual geographical environment and weather changes are beyond human control, or even under the condition that not every frame of captured images is clear or some frames lack distinct lane line features for recognition, is one of the issues to be addressed in the relevant technological field. Specifically, the method may achieve relatively high accuracy by relying on relatively low-level computational capabilities, without requiring relatively complex artificial intelligence algorithms for image recognition.

Therefore, an object of the disclosure is to provide a lane line detection method and system that can alleviate at least one of the drawbacks of the prior art.

According to the disclosure, a first method for a travelling vehicle to detect lane lines is provided. The travelling vehicle is equipped with a front camera module and a rear camera module that capture images at a same frame rate, and a speed sensor module to sense a travelling speed of the travelling vehicle. The method is implemented by a processor, and includes steps of: (A) collecting a historical speed trajectory of the travelling vehicle from the speed sensor module during a first recent time period, N frames of front image that were consecutively captured by the front camera module during the first recent time period, and N frames of rear image that were consecutively captured by the rear camera module during the first recent time period, and collecting M frames of front image that were consecutively captured by the front camera module during a second recent time period that is not shorter than the first recent time period, where M≥N; (B) determining, based on the frame rate, the historical speed trajectory and a length of the travelling vehicle, N1 pairs of matched images from among the N frames of front image and the N frames of rear image, where N>N1, wherein the N1 pairs of matched images include N1 frames of front image from among the N frames of front image, and N1 frames of rear image from among the N frames of rear image, and the N1 frames of rear image respectively match the N1 frames of front image, and wherein each pair of the N1 pairs of matched images includes a first image that is a respective one of the N1 frames of front image, and a second image that is a respective one of the N1 frames of rear image and that matches the first image; (C) determining, for each matched image in the N1 pairs of matched images that is one of the N1 frames of front image and the N1 frames of rear image, whether the matched image has a lane line feature, thereby obtaining a historical lane line detection result that indicates, from among the N1 frames of front image, N11 frames of front image each having the lane line feature, and N11 number of feature values respectively of the lane line features of the N11 frames of front image, where N1≥N11, wherein the historical lane line detection result further indicates N2 pairs of matched images from among the N1 pairs of matched images, and the N2 pairs of matched images include N2 frames of front image from among the N1 frames of front image, and N2 frames of rear image from among the N1 frames of rear image, the N2 frames of rear image respectively match the N2 frames of front image, each frame of the N2 frames of front image and the N2 frames of rear image was determined as having the lane line feature, and N11≥N2; (D) identifying N3 pairs of matched images from among the N2 pairs of matched images based on a predetermined reference similarity, where N2≥N3, and calculating

$$P ( H ) = \frac{N 3}{N} ;$$

(E) determining, for each of the M frames of front image, whether the frame of front image has a lane line feature, obtaining feature values of the lane line features of those of the M frames of front image that were detected as having a lane line feature, and obtaining a reference feature value range related to a ground truth of detection of the lane lines based on a distribution of the feature values of the lane line features of those of the M frames of front image that were detected as having a lane line feature; (F) identifying N111 number of the feature values from among the N11 number of the feature values, where the N111 number of the feature values fall within the reference feature value range, and N11≥N111, and calculating

$$P ( B ) = \frac{N 111}{N 11} ;$$

(G) identifying N31 number of the feature values from among the N3 number of the feature values, where the N31 number of the feature values fall within the reference feature value range, where N3≥N31, and calculating

$$P ( B \vert H ) = \frac{N 31}{N 3} ;$$

(H) receiving a current front image and a current rear image respectively from the front camera module and the rear camera module, determining whether the current front image has a lane line feature, and determining whether the current rear image has a lane line feature; (I) in response to determining that the current front image has a lane line feature and identifying that P(B|H) is not smaller than a predetermined first reference probability, outputting the lane line feature of the current front image as a current lane line detection result; (J) calculating

$$P ( H \vert B ) = \frac{P ( B \vert H ) \times P ( H )}{P ( B )}$$

in response to determining that the current front image does not have a lane line feature and that the current rear image has a lane line feature; and (K) in response to that P(H|B) is not smaller than a second predetermined reference probability, performing coordinate transformation on the lane line feature of the current rear image based on a location and a capture direction of the front camera module and a location and a capture direction of the rear camera module, and outputting the lane line feature of the current rear image that has undergone the coordinate transformation as the current lane line detection result.

According to the disclosure, a system for a travelling vehicle to detect lane lines is provided. The travelling vehicle is equipped with a front camera module and a rear camera module that capture images at a same frame rate, and a speed sensor module to sense a travelling speed of the travelling vehicle. The system includes a connection interface module to be connected to the front camera module, the rear camera module and the speed sensor module, a temporary data storage module, and a processor electrically connected to the connection interface module and the temporary data storage module, and configured to perform the first method. The processor is configured to collect the historical speed trajectory of the travelling vehicle, the N frames of front images, the N frames of rear images and the M frames of front images through the connection interface module, and to store the historical speed trajectory of the travelling vehicle, the N frames of front images, the N frames of rear images and the M frames of front images in the temporary data storage module.

According to this disclosure, a second method for a travelling vehicle to detect lane lines is provided. The travelling vehicle is equipped with a front camera module and a rear camera module that capture images at a same frame rate, and a speed sensor module to sense a travelling speed of the travelling vehicle. The method is implemented by a processor, and includes steps of: (A) collecting a historical speed trajectory of the travelling vehicle during a first recent time period, N frames of front image that were consecutively captured by the front camera module during the first recent time period, and N frames of rear image that were consecutively captured by the rear camera module during the first recent time period, and collecting M frames of front image that were consecutively captured by the front camera module during a second recent time period that is not shorter than the first recent time period, where M≥ N; (B) determining N1 pairs of matched images from among the N frames of front image and the N frames of rear image; (C) determining, for each matched image in the N1 pairs of the matched images that is one of the N1 frames of front image and the N1 frames of rear image, whether the matched image has a lane line feature, thereby obtaining a detection result that indicates a number of occurrences of a first event during the first recent time period, and feature values of the lane line features of those of the matched images that have a lane line feature, where the first event is that the front camera module has captured the lane lines, and wherein, in step C), the processor further determines, based on the detection result, a number of occurrences of a second event during the first recent time period, where the second event is that both of the front camera module and the rear camera module have captured the lane lines, and calculating a first probability based on a proportion of occurrence of the second event during the first recent time period; (D) determining whether each of the M frames of front image has a lane line feature, obtaining feature values of the lane line features of those of the M frames of front image that were determined as having a lane line feature, and obtaining a reference feature value range related to a ground truth of detection of the lane lines based on a distribution of the feature values of the lane line features of those of the M frames of front image that were determined as having a lane line feature; (E) identifying, among the occurrences of the first event, a number of occurrences of a third event where one of the feature values falls within the reference feature value range, and calculating a second probability based on a proportion of occurrence of the third event given that the first event has occurred; (F) calculating a third probability, which is a probability of occurrence of the third event given that the second event has occurred; (G) receiving a current front image and a current rear image respectively from the front camera module and the rear camera module, determining whether the current front image has a lane line feature, and determining whether the current rear image has a lane line feature; (H) in response to determining that the current front image has a lane line feature and identifying that the third probability is not smaller than a predetermined first reference probability, outputting the lane line feature of the current front image as a current lane line detection result; (I) calculating a fourth probability based on the third probability in response to determining that the current front image does not have a lane line feature and that the current rear image has a lane line feature, where the fourth probability is a probability of occurrence of the second event given that the third event has occurred; and (J) in response to that the fourth probability is not smaller than a second predetermined reference probability, performing coordinate transformation on the lane line feature of the current rear image based on a location and a capture direction of the front camera module and a location and a capture direction of the rear camera module, and outputting the lane line feature of the current rear image that has undergone the coordinate transformation as the current lane line detection result.

According to this disclosure, a system for a travelling vehicle to detect lane lines of a lane is provided. The travelling vehicle is equipped with a front camera module and a rear camera module that capture images at a same frame rate, and a speed sensor module to sense a travelling speed of the travelling vehicle. The system includes a connection interface module to be connected to the front camera module, the rear camera module and the speed sensor module, a temporary data storage module, and a processor electrically connected to the connection interface module and the temporary data storage module, and configured to perform the second method. The processor is configured to collect the historical speed trajectory of the travelling vehicle, the N frames of front image, the N frames of rear image and the M frames of front image through the connection interface module, and to store the historical speed trajectory of the travelling vehicle, the N frames of front image, the N frames of rear image and the M frames of front image in the temporary data storage module.

According to this disclosure, a third method for a travelling vehicle to detect lane lines of a lane is provided. The travelling vehicle is equipped with a front camera module and a rear camera module. The front camera module captures multiple frames of front image of the travelling vehicle, and the rear camera module captures multiple frames of rear image of the travelling vehicle. The method is implemented by a processor, and includes steps of: A) obtaining multiple pairs of matched images, each of the multiple pairs including one of the multiple frames of front image and one of the multiple frames of rear image that correspond to a same region of the lane; B) obtaining feature values of lane line features in the multiple pairs of matched images; C) determining whether or not a predetermined probabilistic correlation condition among the feature values of the lane line features in the multiple pairs of matched images is satisfied; D) receiving a current front image from the front camera module, and determining whether the current front image has a lane line feature; and E) in response to in determining that the current front image has a lane line feature and that the predetermined probabilistic correlation condition among the feature values of the lane line features in the multiple pairs of matched images is satisfied, outputting the lane line feature of the current front image as a current lane line detection result.

According to this disclosure, a system for a travelling vehicle to detect lane lines of a lane is provided. The travelling vehicle is equipped with a front camera module and a rear camera module. The front camera module captures multiple frames of front image of the travelling vehicle, and the rear camera module captures multiple frames of rear image of the travelling vehicle. The system includes a connection interface module to be connected to the front camera module and the rear camera module, a temporary data storage module, and a processor electrically connected to the connection interface module and the temporary data storage module. The processor is configured to perform the third method, to collect the multiple frames of front image and the multiple frames of rear image through the connection interface module, and to store the multiple frames of front image and the multiple frames of rear image in the temporary data storage module.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an embodiment of a lane line detection system according to the disclosure.

FIGS. 2A and 2B provide a flow chart illustrating an embodiment of a lane line detection method according to the disclosure.

FIG. 3 is a table illustrating correspondence between assigned index numbers and historical speeds of a vehicle according to the disclosure.

FIG. 4 is a table illustrating correspondence between assigned index numbers and frames of front (rear) image of the vehicle according to the disclosure.

FIG. 5 exemplarily shows a front image and a rear image of a matched image pair according to the disclosure.

FIG. 6 exemplarily shows a front image and a transformed rear image according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

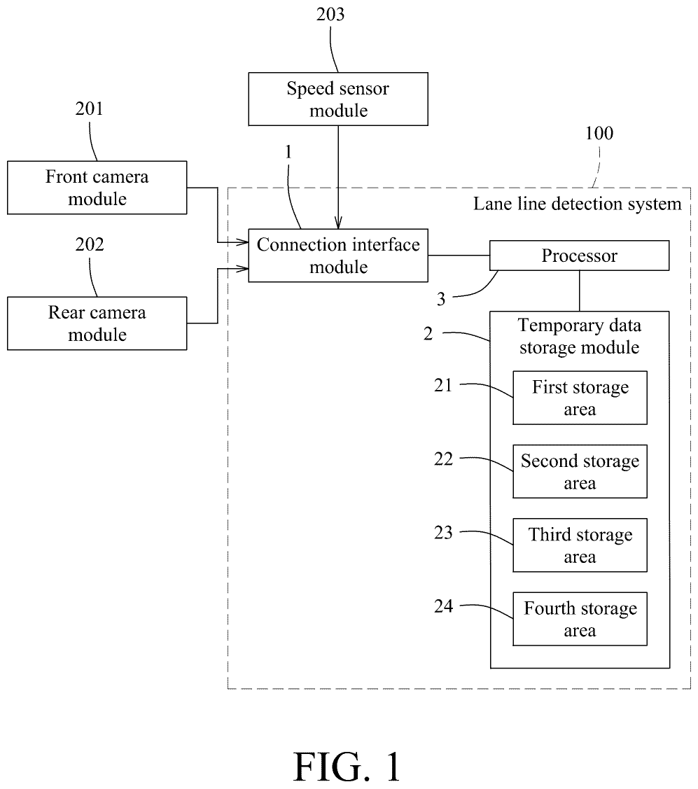

Referring to FIG. 1, an embodiment of a lane line detection system 100 is provided for a vehicle (not shown) to detect lane lines according to this disclosure. The vehicle is equipped with a front camera module 201 and a rear camera module 202 near a front windshield and a rear windshield, respectively, and a speed sensor module 203. The front camera module 201 and the rear camera module 202 are operable to synchronously capture a front image and a rear image of the vehicle at the same frame rate. The speed sensor module 203 is configured to sense a travelling speed of the vehicle. In practice, the front camera module 201, the rear camera module 202 and the speed sensor 203 may be realized using a conventional dashcam device, and the lane line detection system 100 may be connected between the dashcam device and a lane departure warning system (not shown), so that the lane departure warning system may determine whether to issue a lane departure warning based on a result of lane line detection generated by the lane line detection system 100. In the illustrative embodiment, the lane line detection system 100 includes a connection interface module 1, a temporary data storage module 2 and a processor 3.

The connection interface module 1 is electrically connected to the front camera module 201, the rear camera module 202 and the speed sensor module 203. In accordance with some embodiments, the connection interface module 1 may include, for example, a universal serial bus (UBS) module, a Wi-Fi module, a Bluetooth® module, other suitable communication modules, or any combination thereof.

In this embodiment, the temporary data storage module 2 is arranged to include a first storage area 21, a second storage area 22, a third storage area 23 and a fourth storage area 24. The first storage area 21 is configured to store travelling speed data of the vehicle. The second storage area 22 and the fourth storage area 24 are configured to store image data acquired by the front camera module 201. The third storage area 23 is configured to store image data acquired by the rear camera module 202. In this embodiment, each of the first to fourth storage areas 21-24 operates, for example, on a first-in-first-out basis for data removal or writing. In accordance with some embodiments, the temporary data storage module 2 may include, for example, a secure digital (SD) memory card, other suitable storage media, or any combination thereof.

The processor 3 is electrically connected to the connection interface module 1 and the temporary data storage module 2, and is configured to use a conventional lane detection technique to identify whether a lane line feature is present in an image. In the conventional lane detection technique, factors that would affect the detection results may include road cleanness, quality of lane paint, ambient light conditions on the road, white balance of camera modules, traffic flow on the road, etc., and these factors are difficult to represent through simple parameters and functions. In this embodiment, the processor 3 utilizes the conventional lane detection technique to perform detection on each image frame captured by the front camera module 201 or the rear camera module 202, and to determine whether the image frame has a lane line feature. In accordance with some embodiments, the processor 3 calculates an average of edge gradient values of the detected lane line feature or an average of brightness in a color space (e.g., hue, saturation, value, HSV color space) of the lane line feature.

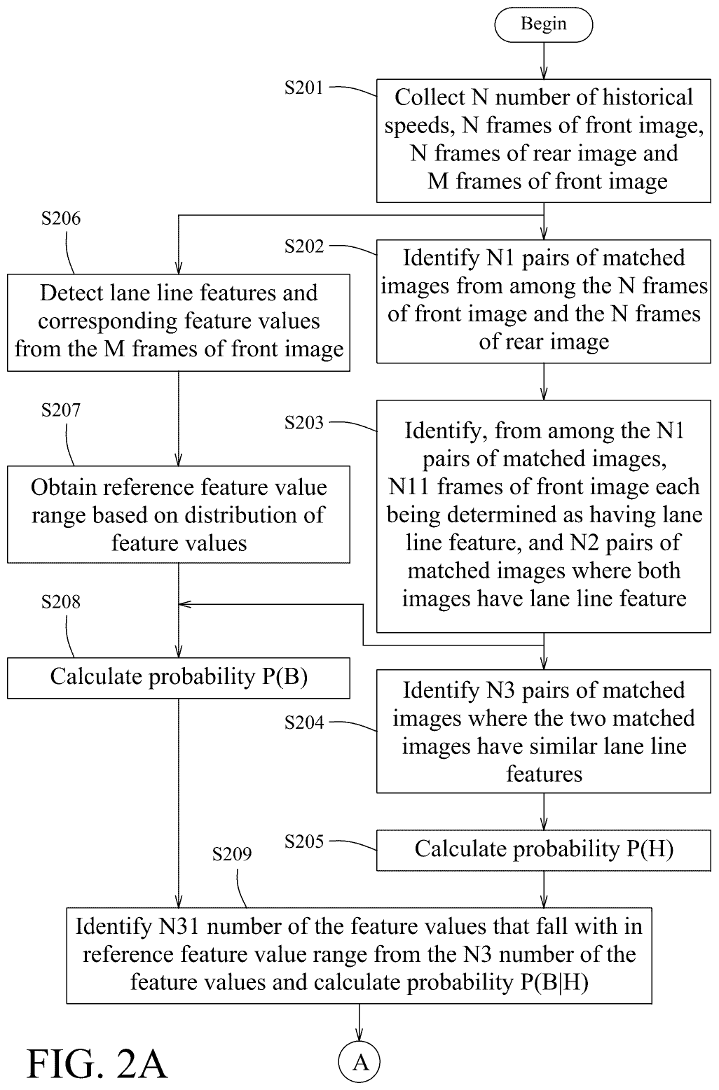

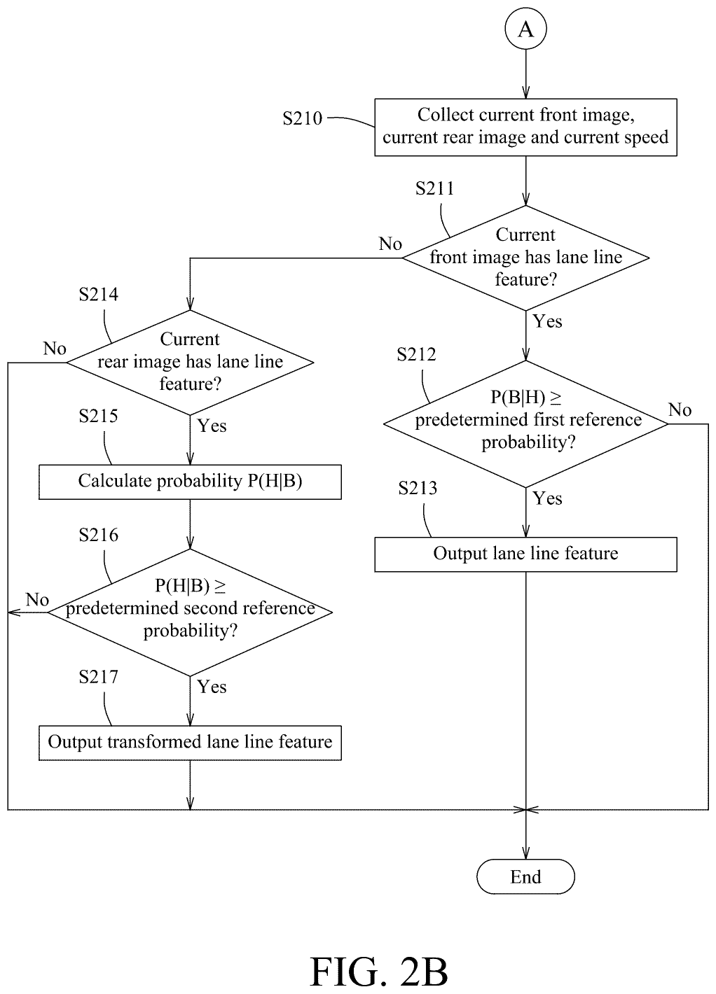

FIGS. 2A and 2B cooperate with FIG. 1 to illustrate a lane line detection procedure to be implemented by the processor 3 when the vehicle is travelling on a road according to this disclosure.

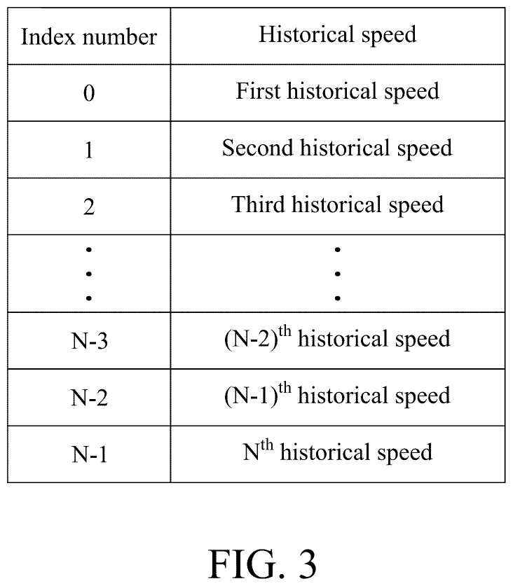

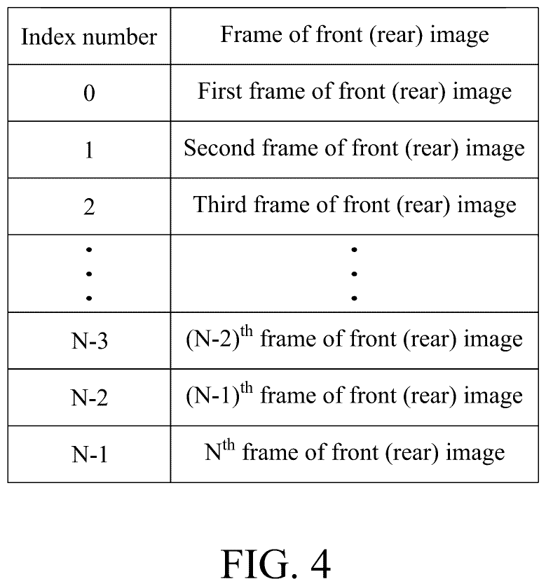

In step S201, through the connection interface module 1, the processor 3 collects a historical speed trajectory of the vehicle during a first recent time period (or called a first sampling time period) from the speed sensor module 203, N frames of front image that were consecutively captured by the front camera module 201 during the first recent time period, and N frames of rear image that were consecutively captured by the rear camera module 202 during the first recent time period, and collects M frames of front image that were consecutively captured by the front camera module 201 during a second recent time period (or called a second sampling time period) that is not shorter than the first recent time period, where M≥N. Meanwhile, the processor 3 stores the historical speed trajectory into the first storage area 21, the N frames of front image into the second storage area 22, the N frames of rear image into the third storage area 23, and the M frames of front image into the fourth storage area 24. In this embodiment, the historical speed trajectory of the vehicle includes N number of historical speeds sensed by the speed sensor module 203 at N number of historical time points when the N frames of front image were respectively captured by the front camera module 201 (or when the N frames of rear image were respectively captured by the rear camera module 202). The N number of the historical speeds are sequentially stored into the first storage area 21 and are respectively assigned consecutive index numbers, following a principle that the earlier the historical speed was sensed, the smaller the index number, as illustrated in FIG. 3. The N frames of front image are sequentially stored into the second storage area 22 and are respectively assigned consecutive index numbers, following a principle that the earlier the frame was sensed, the smaller the index number, as illustrated in FIG. 4. The N frames of rear image are sequentially stored into the third storage area 23 and are respectively assigned with index numbers, following a principle that the earlier the frame was sensed, the smaller the index number, as illustrated in FIG. 4. In accordance with some embodiments, the historical speed, the frame of front image and the frame of rear image that were acquired at the same historical time point are assigned the same index number. For example, assuming that the first recent time period is 30 seconds long and is the 30 seconds that are immediately prior to a current time point, the second recent time period is 300 seconds long and is the 300 seconds that are immediately prior to the current time point, and the frame rate is 15 frames per second (fps), then N=15×30=450, and M=15×300=4500. In this case, the N number of the historical speeds may be respectively represented using V(0), V(1), V(2), . . . , V(447), V(448) and V(449), the N frames of front image may be respectively represented using I_{F}(0), I_{F}(1), I_{F}(2), . . . , I_{F}(447), I_{F}(448) and I_{F}(449), and the N frames of rear image may be respectively represented using I_{R}(0), I_{R}(1), I_{R}(2), . . . , I_{R}(447), I_{R}(448) and I_{R}(449), where the numbers 0 to 449 are index numbers, but this disclosure is not limited to such. In this embodiment, the second recent time period is longer than the first recent time period, so M is greater than N. In other embodiments where the second recent time period is equal in length to the first recent time period (meaning that the second recent time period is the first recent time period), then M would be equal to N. In such a case, since the second storage area 22 and the fourth storage area 24 would store the same frames of front image, the fourth storage area 24 can be omitted. After step S201, the flow goes to step S202 and step S206.

In step S202, the processor 3 determines N1 pairs of matched images from among the N frames of front image and the N frames of rear image, and such determination is based on the frame rate, the N number of the historical speeds of the historical speed trajectory (measured in m/s), a length of the vehicle (measured in meter), and a delay parameter, where N>N1, and the delay parameter ranges between 0 and 1 and is associated with a tolerance of computation process that may be influenced by factors related to an environment the processor 3 is in (such as transmission delay of image frames, varying traveling speed of the vehicle, etc.). The N1 pairs of matched images include N1 frames of front image from among the N frames of front image, and N1 frames of rear image from among the N frames of rear image, and the N1 frames of rear image respectively match the N1 frames of front image. Each pair of the N1 pairs of matched images includes a first image and a second image, where the first image is a respective one of the N1 frames of front image, and the second image is a respective one of the N1 frames of rear image and matches the first image. Specifically, the processor 3 determines which frame of rear image matches a frame of front image based on the index number of the frame of front image, the length of the vehicle, the historical speed with the same index number as the frame of front image, the frame rate and the delay parameter. Assuming that the frame of front image is represented by I_{F}(i), the processor 3 may determine the frame of rear image that matches the frame of front image I_{F}(i) according to:

$$j = i + int ( L / V ( i ) \times FR + DP ) ,$$

where j is the index number of the frame of rear image that matches the frame of front image I_{F}(i) (i.e., the frame of rear image thus determined is represented by I_{R}(j)), int( ) is a function used to round a number to an integer, L represents the length of the vehicle, FR represents the frame rate, and DP represents the delay parameter. For example, assuming FR=15 fps, L=4.5 meters and DP=0.9, in a case where i=0 and V(0)=100 km/hr=27.777 m/s, j=0+int(4.5/27.777×15+0.9)=0+int(3.33)=3, then the processor 3 would determine (I_{F}(0), I_{R}(3)) to be the first pair of matched images. Subsequently, in a case where i=1 and V(1)=110 km/hr=30.555 m/s, j=1+int(4.5/30.555×15+0.9)=0+int(3.109)=4, then the processor 3 would determine (I_{F}(1), I_{R}(4)) to be the second pair of matched images. Similarly, the processor 3 can determine the N1 pairs of matched images from the N frames of front image and the N frames of rear image.

In step S203, the processor 3 utilizes the lane detection technique to determine, for each matched image in the N1 pairs of matched images that is one of the N1 frames of front image and the N1 frames of rear image, whether the matched image has a lane line feature, thereby obtaining a first historical lane line detection result. In this step, the processor 3 identifies, from among the N1 frames of front image, N11 frames of front image each being determined as having a lane line feature, and obtains N11 number of feature values respectively of the lane line features of the N11 frames of front image, where N1≥N11. In other words, N11 represents a number of occurrences of an event (referred to as “event (F)” hereinafter) where lane lines were captured by the front camera module 201 during the first recent time period. In this step, the processor 3 further identifies N2 pairs of matched images from among the N1 pairs of matched images, where the N2 pairs of matched images include N2 frames of front image from among the N1 frames of front image, and N2 frames of rear image from among the N1 frames of rear image, the N2 frames of rear image respectively match the N2 frames of front image, each frame of the N2 frames of front image and the N2 frames of rear image was determined as having a lane line feature, and N11≥N2. The first historical lane line detection result indicates the N11 frames of front image, the N11 number of feature values, and the N2 pairs of matched images.

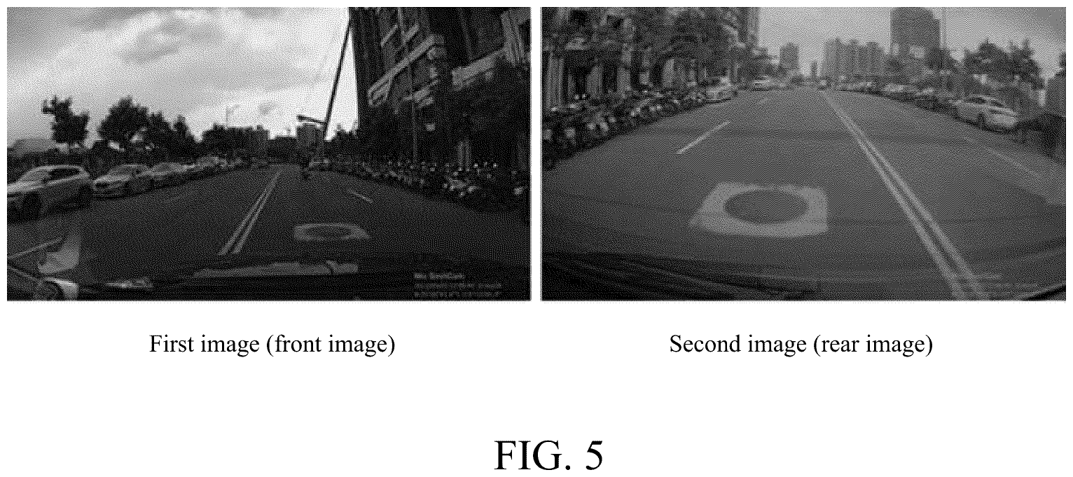

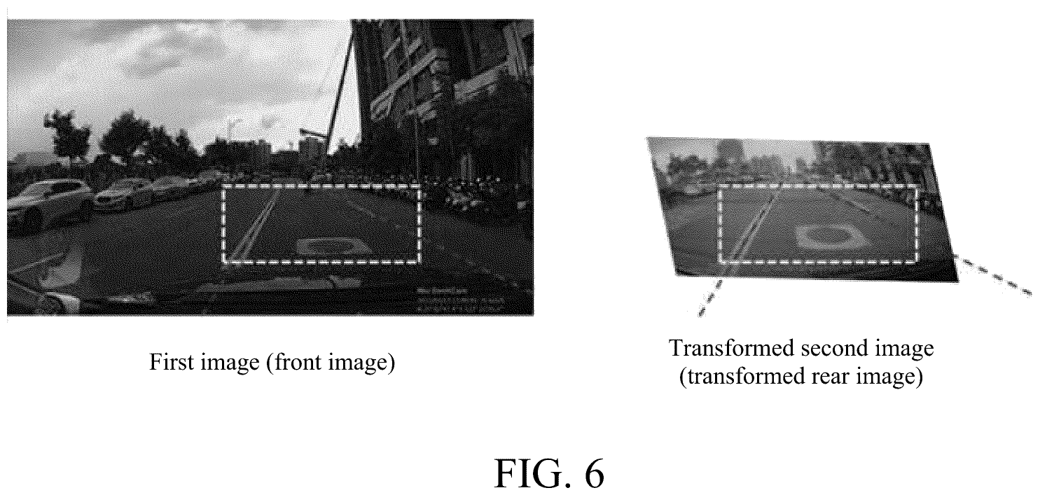

In step S204, the processor 3 utilizes a conventional sample region (e.g., region of interest, ROI) matching technique to calculate, for each pair of the N2 pairs of matched images (e.g., the first image and the second image of the pair, which are respectively one of the N2 frames of front image and one of the N2 frames of rear image that match, as exemplified in FIG. 5), a degree of similarity between a sample region of the first image of the pair and a sample region of the second image of the pair at a location of the lane line feature. Then, the processor 3 determines whether the degree of similarity thus calculated is not smaller than a predetermined reference similarity (for example but not limited to 90%). When the calculated degree of similarity is not smaller than the predetermined reference similarity, the pair of matched images (i.e., the first image and the second image) are determined to have similar lane line features (referred to as an “event (H)” where both of the front camera module 201 and the rear camera module 202 have captured the lane lines). Otherwise, the pair of matched images are determined not to have similar lane features (i.e., one of the front camera module 201 and the rear camera module 202 did not capture the lane lines). In accordance with some embodiments, before calculating the degree of similarity between the first image and the second image for each pair of matched images, the processor 3 performs coordinate transformation on the lane line feature of the second image (see the second image in FIG. 5) based on a location and a capture direction of the front camera module 201 and a location and a capture direction of the rear camera module 202, so that the transformed second image (see the transformed second image in FIG. 6) can be projected onto the same coordinate plane as the first image (see the first image in either FIG. 5 or FIG. 6). Since the focus of this disclosure does not reside in the coordinate transformation, relevant details are omitted herein for the sake of brevity. Subsequently, the processor 3 extracts the sample region (see dashed rectangular blocks in FIG. 6) that contains the lane line feature (see dashed straight lines in FIG. 6) from each of the first image and the transformed second image, and utilizes a function of image similarity R(x, y) to calculate the degree of similarity between the sample region of the first image and the sample region of the transformed second image at the location of the lane line feature. In this embodiment, the function of image similarity is exemplified as:

$$R ( x , y ) = \frac{{\sum }_{{x}^{′} , {y}^{′}} {( T ( {x}^{′} , {y}^{′} ) - I ( x + {x}^{′} , y + {y}^{′} ) )}^{2}}{\sqrt{{\sum }_{{x}^{′} , {y}^{′}} {T ( {x}^{′} , {y}^{′} )}^{2} \cdot {\sum }_{{x}^{′} , {y}^{′}} {I ( x + {x}^{′} , y + {y}^{′} )}^{2}}} ,$$

where (x, y) represents a location of a pixel in the sample regions of the first image and the transformed second image, T( ) represents a pixel value at a given location in the sample region of the first image, I( ) represents a pixel value at a given location in the sample region of the transformed second image, and x′ and y′ represent displacements of the lane line feature relative to the location (x, y) respectively in an X-axis direction (e.g., a horizontal direction in FIG. 6) and a Y-axis direction (e.g., a vertical direction in FIG. 6). After calculating N2 number of the degrees of similarity respectively for the N2 pairs of matched images, the processor 3 identifies N3 pairs of matched images from among the N2 pairs of matched image, where N2≥N3, and for each pair of the N3 pairs of matched images, the first image and the second image have similar lane line features (i.e., the degree of similarity between the sample region of the first image of the pair and the sample region of the transformed second image of the pair at the location of the lane line feature is not smaller than the predetermined reference similarity). In other words, N3 represents a number of occurrences of the event (H) during the first recent time period.

In step S205, the processor 3 calculates a prior probability P(H) of the event (H) by calculating a proportion of occurrence of the event (H) during the first recent time period, namely

$$\frac{N 3}{N} .$$

In step S206, the processor 3 uses the aforesaid conventional lane detection technique to determine, for each of the M frames of front image, whether the frame of front image has a lane line feature, and obtains feature values of the lane line features of those of the M frames of front image that were determined as having a lane line feature, thereby obtaining a second historical lane line detection result that indicates the feature values thus obtained.

In step S207, the processor 3 obtains a reference feature value range related to a ground truth of detection of the lane lines based on a distribution of the feature values of the lane line features of those of the M frames of front image that were determined as having a lane line feature. The reference feature value range serves as an optimal range for the feature values of the lane line features of those of the M frames of front image that were determined as having a lane line feature in this disclosure. In this embodiment, the distribution of the feature values of the lane line features of those of the M frames of front image that were determined as having a lane line feature is a Gaussian distribution (also known as a normal distribution). The ground truth is an interval derived from an average of the feature values, spanning from one standard deviation of the distribution below the average of the feature values to one standard deviation of the distribution above the average of the feature values, and the interval serves as the optimal range for the feature values of the lane line features of those of the M frames of front image that were determined as having a lane line feature (i.e., the reference feature value range).

In step S208, which follows step S203 and step S207, the processor 3 identifies N111 number of the feature values from among the N11 number of the feature values, where N11≥N111, and the N111 number of the feature values fall within the reference feature value range. In this disclosure, a feature value of a lane line feature of a frame of front image falling within the reference feature value range is referred to as an event (B), so N111 represents a number of occurrences of the event (B) out of the N11 number of the feature values that are related to the event (F). In this step, the processor 3 further calculates a prior probability P(B) of the event (B) by calculating a proportion of occurrence of the event (B) among the occurrences of the event (F), namely

$$\frac{N 111}{N 11} .$$

The prior probability P(B) of event (B) is a probability of the event (B) given that the event (F) has occurred.

In step S209, which follows step S205 and step S208, the processor 3 identifies N31 number of the feature values from among the N3 number of the feature values, where N3≥N31, and the N31 number of the feature values fall within the reference feature value range. N31 represents a number of occurrences of the event (B) in the N3 number of the feature values that are related to the event (H). In this step, the processor 3 further calculates a posterior probability P(B|H) of the event (B) by calculating a proportion of occurrence of the event (B) among the occurrences of the event (H), namely

$$\frac{N 31}{N 3} .$$

The posterior probability P(B|H) of event (B) is a probability of the event (B) given that the event (H) has occurred, and means a probability of the feature values detected from the frames of front image falling within the reference feature value range (namely, the ground truth), given that both of the front camera module 201 and the rear camera module 202 have captured the lane lines of the lane.

In step S210, through the connection interface module 1, the processor 3 collects a current front image from the front camera module 201, a current rear image from the rear camera module 202, and a current speed of the vehicle sensed by the speed sensor module 203 at a current time point. Then, in step S211, the processor 3 uses the aforesaid conventional lane detection technique to determine whether the current front image has a lane line feature. The flow goes to step S212 when the current front image is determined as having a lane line feature, and goes to step S214 when otherwise.

In step S212, the processor 3 determines whether the posterior probability P(B|H) is not smaller than a predetermined first reference probability (for example, but not limited to, 0.9). Upon determining that the posterior probability P(B|H) is not smaller than the predetermined first reference probability, the flow goes to step S213, where the processor 3 outputs the lane line feature of the current front image as a current lane line detection result, and the flow ends. In practice, the processor 3 outputs the current lane line detection result to the lane departure warning system, so the lane departure warning system uses the current lane line detection result as a basis to determine whether to issue a lane departure warning, thereby ensuring a relatively accurate determination on issuance of the lane departure warning. To the contrary, when the processor 3 determines that the posterior probability P(B|H) is smaller than the predetermined first reference probability, which means that the lane line feature detected from the current front image is not reliable and is not suitable for serving as a basis for determining whether to issue the lane departure warning, the processor 3 does not output the lane line feature detected from the current front image, and terminates the flow, so as to prevent misjudgments in issuance of the lane departure warning due to unreliable lane line feature.

In step S214, the processor 3 uses the aforesaid conventional lane detection technique to determine whether the current rear image has a lane line feature. The flow ends when the current rear image is detected as not having a lane line feature, which means that the processor 3 did not detect any lane line feature from both of the current front image and the current rear image. Otherwise, the flow goes to step S215.

Since the probability of occurrence of the event (B) given that the event (H) has occurred is different from the probability of occurrence of the event (H) given that the event (B) has occurred, in step S215, the processor 3 calculates a probability P(H|B) of occurrence of the event (H) given that the event (B) has occurred based on the probabilities P(B|H), P(H) and P(B). In accordance with some embodiments, the probability P(H|B) may be calculated using, for example, the Bayes' theorem. In this embodiment, the probability P(H|B) is calculated according to

$$P ( H \vert B ) = \frac{P ( B \vert H ) \times P ( H )}{P ( B )} .$$

The probability P(H|B) is a posterior probability of the event (H), which means a probability of both of the front camera module 201 and the rear camera module 202 having captured the lane lines of the lane, given that the feature value detected from the front image falls within the reference feature value range (i.e., the ground truth).

In step S216, the processor 3 determines whether the probability P(H|B) is not smaller than a second predetermined reference probability (for example, but not limited to, 0.9). When determining that the probability P(H|B) is not smaller than the second predetermined reference probability, the flow goes to step S217, where the processor 3 performs the aforesaid coordinate transformation on the lane line feature of the current rear image, and outputs the transformed lane line feature (i.e., the lane line feature of the current rear image that has undergone the coordinate transformation) as the current lane line detection result, followed by terminating the flow. In this embodiment, even though the current front image may not be determined as having any lane line feature due to poor image quality, in the case where the current rear image is determined as having a reliable lane line feature, the processor 3 would still output the current lane line detection result that is the transformed lane line feature obtained from the current rear image to the lane departure warning system, so the lane departure warning system can use the current lane line detection result as a basis to determine whether to issue a lane departure warning, thereby reducing a missed detection rate in lane departure warnings resulting from failure to detect a lane line feature from the current front image. In contrast, when the processor 3 determines that the probability P(H|B) is smaller than the second predetermined reference probability, which means that the lane line feature detected from the current rear image is not reliable and is not suitable for serving as a basis for determining whether to issue the lane departure warning, the processor 3 does not output the lane line feature detected from the current rear image, and terminates the flow, so as to prevent misjudgments in issuance of the lane departure warning due to unreliable lane line feature.

Hereinafter, an example is provided to explain the probabilities obtained in the lane line detection procedure. In this example, the frame rate is 15 fps, the first recent time period is 30 seconds long, the second recent time period is 300 seconds long, N=450, and M=4500. When N11=430 in step S203 and N3=400 in step S204, the probability

$$P ( H ) = \frac{N 3}{N} = \frac{400}{450} = 0.8888$$

in step S205. When N111=385 in step S208, the probability

$$P ( B ) = \frac{N 111}{N 11} = \frac{385}{430} = 0.8953$$

in step S208. When N31=370 in step S209, the probability

$$P ( B \vert H ) = \frac{N 31}{N 3} = \frac{370}{400} = 0.925$$

in step S209, and the probability

$$P ( H \vert B ) = \frac{P ( B \vert H ) \times P ( H )}{P ( B )} = \frac{0.925 \times 0.8888}{0.8953} = 0.9182$$

in step S215.

It is noted that, after the processor 3 receives the current front image, the current rear image and the current speed and before the next execution of the lane line detection procedure, the processor 3 removes the earliest one of the historical speeds (e.g., the first historical speed in FIG. 3) from the first storage area 21 and stores the current speed in the first storage area 21 as a new historical speed (serving as a latest one of the historical speeds), removes the earliest one of the N frames of front image (e.g., the first frame of front image in FIG. 4) from the second storage area 22 and stores the current front image in the second storage area 22 as a new frame of the N frames of front image (serving as a latest one of the N frames of front image), removes the earliest one of the N frames of rear image (e.g., the first frame of rear image in FIG. 4) from the third storage area 23 and stores the current rear image in the third storage area 23 as a new frame of the N frames of rear image (serving as a latest one of the N frames of rear image), and removes the earliest one of the M frames of front image from the fourth storage area 24 and stores the current front image in the fourth storage area 24 as a new frame of the M frames of front image (serving as a latest one of the M frames of front image).

In summary, by detecting and analyzing the lane line feature from the frames of front image captured during the second recent time period, the reference feature value range can be obtained. The reference feature value range, together with the pairs of matched images that are generated from the frames of front image and the frames of rear image captured during the first recent time period, can be used to calculate various event probabilities and posterior probabilities under different conditions. According to the posterior probabilities and the corresponding predetermined reference probabilities, reliabilities of the current detection of the lane lines can be verified. This approach effectively reduces the misjudgment rate and/or missed detection rate in lane departure warnings due to factors such as changes in physical environment and weather, without the need for relatively complex artificial intelligence algorithms.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for a travelling vehicle to detect lane lines, the travelling vehicle being equipped with a front camera module and a rear camera module that capture images at a same frame rate, and a speed sensor module to sense a travelling speed of the travelling vehicle, said method being implemented by a processor, and comprising steps of:
A) collecting a historical speed trajectory of the travelling vehicle from the speed sensor module during a first recent time period, N frames of front image that were consecutively captured by the front camera module during the first recent time period, and N frames of rear image that were consecutively captured by the rear camera module during the first recent time period, and collecting M frames of front image that were consecutively captured by the front camera module during a second recent time period that is not shorter than the first recent time period, where M≥N;
B) determining, based on the frame rate, the historical speed trajectory and a length of the travelling vehicle, N1 pairs of matched images from among the N frames of front image and the N frames of rear image, where N>N1, wherein the N1 pairs of matched images include N1 frames of front image from among the N frames of front image, and N1 frames of rear image from among the N frames of rear image, and the N1 frames of rear image respectively match the N1 frames of front image, and wherein each pair of the N1 pairs of matched images includes a first image that is a respective one of the N1 frames of front image, and a second image that is a respective one of the N1 frames of rear image and that matches the first image;
C) determining, for each matched image in the N1 pairs of matched images that is one of the N1 frames of front image and the N1 frames of rear image, whether the matched image has a lane line feature, thereby obtaining a historical lane line detection result that indicates, from among the N1 frames of front image, N11 frames of front image each having the lane line feature, and N11 number of feature values respectively of the lane line features of the N11 frames of front image, where N1≥N11,
wherein the historical lane line detection result further indicates N2 pairs of matched images from among the N1 pairs of matched images, and the N2 pairs of matched images include N2 frames of front image from among the N1 frames of front image, and N2 frames of rear image from among the N1 frames of rear image, the N2 frames of rear image respectively match the N2 frames of front image, each frame of the N2 frames of front image and the N2 frames of rear image was determined as having the lane line feature, and N11≥N2;
D) identifying N3 pairs of matched images from among the N2 pairs of matched images based on a predetermined reference similarity, where N2≥N3, and calculating
$$P ( H ) = \frac{N 3}{N} ;$$
E) determining, for each of the M frames of front image, whether the frame of front image has a lane line feature, obtaining feature values of the lane line features of those of the M frames of front image that were detected as having a lane line feature, and obtaining a reference feature value range related to a ground truth of detection of the lane lines based on a distribution of the feature values of the lane line features of those of the M frames of front image that were detected as having a lane line feature;
F) identifying N111 number of the feature values from among the N11 number of the feature values, where the N111 number of the feature values fall within the reference feature value range, and N11≥N111, and calculating
$$P ( B ) = \frac{N 111}{N 11} ;$$
G) identifying N31 number of the feature values from among the N3 number of the feature values, where the N31 number of the feature values fall within the reference feature value range, where N3≥N31, and calculating
$$P ( B \vert H ) = \frac{N 31}{N 3} ;$$
H) receiving a current front image and a current rear image respectively from the front camera module and the rear camera module, determining whether the current front image has a lane line feature, and determining whether the current rear image has a lane line feature;
I) in response to determining that the current front image has a lane line feature and identifying that P(B|H) is not smaller than a predetermined first reference probability, outputting the lane line feature of the current front image as a current lane line detection result;
J) calculating
$$P ( H \vert B ) = \frac{P ( B \vert H ) \times P ( H )}{P ( B )}$$
in response to determining that the current front image does not have a lane line feature and that the current rear image has a lane line feature; and
K) in response to that P(H|B) is not smaller than a second predetermined reference probability, performing coordinate transformation on the lane line feature of the current rear image based on a location and a capture direction of the front camera module and a location and a capture direction of the rear camera module, and outputting the lane line feature of the current rear image that has undergone the coordinate transformation as the current lane line detection result.

2. The method as claimed in claim 1, wherein, in step D), the processor determines, for each pair of the N2 pairs of matched images, whether a degree of similarity between a sample region of the first image in the pair and a sample region of the second image in the pair at a location of the lane line feature is not smaller than the predetermined reference similarity; and
wherein, for each pair of the N3 pairs of matched images, the degree of similarity between the sample region of the first image in the pair and the sample region of the second image in the pair at the location of the lane line feature is not smaller than the predetermined reference similarity.

3. The method as claimed in claim 1, wherein each of the feature values is one of an average of edge gradient values of the corresponding one of the lane line features, and an average of brightness in a color space of the corresponding one of the lane line features.

4. The method as claimed in claim 1, wherein, in step E), the distribution of the feature values is a Gaussian distribution, the ground truth is an interval derived from an average of the feature values, spanning from one standard deviation of the distribution below the average of the feature values to one standard deviation of the distribution above the average of the feature values, and the interval serves as the reference feature value range.

5. A system for a travelling vehicle to detect lane lines, the travelling vehicle being equipped with a front camera module and a rear camera module that capture images at a same frame rate, and a speed sensor module to sense a travelling speed of the travelling vehicle, said system comprising:
a connection interface module to be connected to the front camera module, the rear camera module and the speed sensor module;
a temporary data storage module; and
a processor electrically connected to said connection interface module and said temporary data storage module, and configured to perform the method as claimed in claim 1,
wherein said processor is configured to collect the historical speed trajectory of the travelling vehicle, the N frames of front images, the N frames of rear images and the M frames of front images through said connection interface module, and to store the historical speed trajectory of the travelling vehicle, the N frames of front images, the N frames of rear images and the M frames of front images in said temporary data storage module.

6. The system as claimed in claim 5, wherein, in step D), said processor determines, for each pair of the N2 pairs of matched images, whether a degree of similarity between a sample region of the first image in the pair and a sample region of the second image in the pair at a location of the lane line feature is not smaller than the predetermined reference similarity; and
wherein, for each pair of the N3 pairs of matched images, the degree of similarity between the sample region of the first image in the pair and the sample region of the second image in the pair at the location of the lane line feature is not smaller than the predetermined reference similarity.

7. The system as claimed in claim 5, wherein each of the feature values is one of an average of edge gradient values of the corresponding one of the lane line features, and an average of brightness in a color space of the corresponding one of the lane line features.

8. The system as claimed in claim 5, wherein, in step E), the distribution of the feature values is a Gaussian distribution, the ground truth is an interval derived from an average of the feature values, spanning from one standard deviation of the distribution below the average of the feature values to one standard deviation of the distribution above the average of the feature values, and the interval serves as the reference feature value range.

9. The system as claimed in claim 5, wherein the historical speed trajectory of the travelling vehicle includes N number of historical speeds sensed by the speed sensor module at N number of historical time points when the N frames of front image were respectively captured by the front camera module;
wherein said temporary data storage module includes a first storage area to sequentially store the N number of the historical speeds, a second storage area to sequentially store the N frames of front image, a third storage area to sequentially store the N frames of rear image, and a fourth storage area to sequentially store the M frames of front image;
wherein said processor is configured to collect a current speed of the travelling vehicle that is sensed by the speed sensor module at a current time point when the current front image is captured by the front camera module; and
wherein said processor is configured to, after receipt of the current front image, the current rear image and the current speed,
remove an earliest one of the historical speeds from said first storage area,
store the current speed in said first storage area as a new historical speed,
remove an earliest one of the N frames of front image from said second storage area,
store the current front image in said second storage area as a new frame of the N frames of front image;
remove an earliest one of the N frames of rear image from said third storage area,
store the current rear image in said third storage area as a new frame of the N frames of rear image,
remove an earliest one of the M frames of front image from said fourth storage area, and
store the current front image in said fourth storage area as a new frame of the M frames of front image.

10. A method for a travelling vehicle to detect lane lines, the travelling vehicle being equipped with a front camera module and a rear camera module that capture images at a same frame rate, and a speed sensor module to sense a travelling speed of the travelling vehicle, said method being implemented by a processor, and comprising steps of:
A) collecting a historical speed trajectory of the travelling vehicle during a first recent time period, N frames of front image that were consecutively captured by the front camera module during the first recent time period, and N frames of rear image that were consecutively captured by the rear camera module during the first recent time period, and collecting M frames of front image that were consecutively captured by the front camera module during a second recent time period that is not shorter than the first recent time period, where M≥N;
B) determining N1 pairs of matched images from among the N frames of front image and the N frames of rear image;
C) determining, for each matched image in the N1 pairs of the matched images that is one of the N1 frames of front image and the N1 frames of rear image, whether the matched image has a lane line feature, thereby obtaining a detection result that indicates a number of occurrences of a first event during the first recent time period, and feature values of the lane line features of those of the matched images that have a lane line feature, where the first event is that the front camera module has captured the lane lines, and
wherein, in step C), the processor further determines, based on the detection result, a number of occurrences of a second event during the first recent time period, where the second event is that both of the front camera module and the rear camera module have captured the lane lines, and calculating a first probability based on a proportion of occurrence of the second event during the first recent time period;
D) determining whether each of the M frames of front image has a lane line feature, obtaining feature values of the lane line features of those of the M frames of front image that were determined as having a lane line feature, and obtaining a reference feature value range related to a ground truth of detection of the lane lines based on a distribution of the feature values of the lane line features of those of the M frames of front image that were determined as having a lane line feature;
E) identifying, among the occurrences of the first event, a number of occurrences of a third event where one of the feature values falls within the reference feature value range, and calculating a second probability based on a proportion of occurrence of the third event given that the first event has occurred;
F) calculating a third probability, which is a probability of occurrence of the third event given that the second event has occurred;
G) receiving a current front image and a current rear image respectively from the front camera module and the rear camera module, determining whether the current front image has a lane line feature, and determining whether the current rear image has a lane line feature;
H) in response to determining that the current front image has a lane line feature and identifying that the third probability is not smaller than a predetermined first reference probability, outputting the lane line feature of the current front image as a current lane line detection result;
I) calculating a fourth probability based on the third probability in response to determining that the current front image does not have a lane line feature and that the current rear image has a lane line feature, where the fourth probability is a probability of occurrence of the second event given that the third event has occurred; and
J) in response to that the fourth probability is not smaller than a second predetermined reference probability, performing coordinate transformation on the lane line feature of the current rear image based on a location and a capture direction of the front camera module and a location and a capture direction of the rear camera module, and outputting the lane line feature of the current rear image that has undergone the coordinate transformation as the current lane line detection result.

11. A system for a travelling vehicle to detect lane lines of a lane, the travelling vehicle being equipped with a front camera module and a rear camera module that capture images at a same frame rate, and a speed sensor module to sense a travelling speed of the travelling vehicle, said system comprising:
a connection interface module to be connected to the front camera module, the rear camera module and the speed sensor module;
a temporary data storage module; and
a processor electrically connected to said connection interface module and said temporary data storage module, and configured to perform the method as claimed in claim 10,
wherein said processor is configured to collect the historical speed trajectory of the travelling vehicle, the N frames of front image, the N frames of rear image and the M frames of front image through said connection interface module, and to store the historical speed trajectory of the travelling vehicle, the N frames of front image, the N frames of rear image and the M frames of front image in said temporary data storage module.

12. A method for a travelling vehicle to detect lane lines of a lane, the travelling vehicle being equipped with a front camera module and a rear camera module, the front camera module capturing multiple frames of front image of the travelling vehicle, the rear camera module capturing multiple frames of rear image of the travelling vehicle, said method being implemented by a processor, and comprising steps of:
A) obtaining multiple pairs of matched images, each of the multiple pairs including one of the multiple frames of front image and one of the multiple frames of rear image that correspond to a same region of the lane;
B) obtaining feature values of lane line features in the multiple pairs of matched images;
C) determining whether or not a predetermined probabilistic correlation condition among the feature values of the lane line features in the multiple pairs of matched images is satisfied;
D) receiving a current front image from the front camera module, and determining whether the current front image has a lane line feature; and
E) in response to determining that the current front image has a lane line feature and that the predetermined probabilistic correlation condition among the feature values of the lane line features in the multiple pairs of matched images is satisfied, outputting the lane line feature of the current front image as a current lane line detection result.

13. A system for a travelling vehicle to detect lane lines of a lane, the travelling vehicle being equipped with a front camera module and a rear camera module, the front camera module capturing multiple frames of front image of the travelling vehicle, the rear camera module capturing multiple frames of rear image of the travelling vehicle, said system comprising:
a connection interface module to be connected to the front camera module and the rear camera module;
a temporary data storage module; and
a processor electrically connected to said connection interface module and said temporary data storage module, and configured to perform the method as claimed in claim 12,
wherein said processor is configured to collect the multiple frames of front image and the multiple frames of rear image through said connection interface module, and to store the multiple frames of front image and the multiple frames of rear image in said temporary data storage module.
